(19) United States
(12) Patent Application Publication
(10) Pub. No.: US 2019/0002666 A1
(43) Pub. Date: Jan. 3, 2019

(54) METHOD FOR PREPARING A SOLID BITUMEN MATERIAL AT AMBIENT TEMPERATURE

(71) Applicants: TOTAL MARKETING SERVICES, Puteaux (FR); CENTRE NATIONAL DE LA RECHERCHE SCIENTIFIQUE, Paris (FR)

(72) Inventors: Pauline ANACLET, Lyon (FR); Viviane JULIEN, Saint Jean de Muzols (FR); Rénal BACKOV, Bordeaux-Cauderan (FR); Véronique SCHMITT, Talence (FR)

(73) Assignees: TOTAL MARKETING SERVICES, Puteaux (FR); CENTRE NATIONAL DE LA RECHERCHE SCIENTIFIQUE, Paris (FR)

(21) Appl. No.: 16/065,152

(22) PCT Filed: Dec. 21, 2016
(86) PCT No.: PCT/FR2016/053599

§ 371 Date: Jun. 22, 2018

(30) Foreign Application Priority Data
Dec. 22, 2015 (FR) 1563103

(51) Int. Cl. C08K 3/36; C10C 3/14

(52) U.S. Cl. CPC C08K 3/36; C10C 3/14

(57) ABSTRACT

A method for preparing a solid bitumen material at ambient temperature, the method comprising at least the steps of: a) preparing a stabilized emulsion of bitumen drops in a water phase that has a pH of 2 to 4; b) preparing a silica sol or silica gel from a first silicon oxide precursor that has a pH of 2 to 4; c) mineralizing the emulsion of bitumen drops from step a) with the silica sol or gel from step b); d) mineralizing the emulsion of bitumen drops from step c) having a maximum pH of 1 with a second silicon oxide precursor; e) separating the material from the water phase.

The present invention lies in the technical field of bitumens. More specifically, the invention relates to a process for obtaining bitumen in divided form, which is solid at ambient temperature, and to the material thus obtained.

The present invention also relates to a process for producing bituminous mixes from solid bitumen according to the invention and also to a process for transporting and/or storing road bitumen which is solid at ambient temperature according to the invention.

### PRIOR ART

Bitumen is a material used in very large quantities as a construction material. Combined with aggregates, fines or reinforcements, bitumen is used for example for the production of road carriageways and leakproofing coverings on roofs or in holding tanks. Bitumen is generally in the form of a black material which has a high viscosity, or is even solid at ambient temperature, and which becomes fluid by heating.

In general, bitumen is stored and transported hot, in bulk, in tanker trucks or by boat at high temperatures of about 120° C. to 160° C. However, hot bitumen storage and transportation have some drawbacks. Firstly, the transportation of hot bitumen in liquid form is considered to be dangerous and highly subject to regulatory control. This mode of transport does not present particular difficulties when the transportation equipment and infrastructure are in good condition. If this is not the case, it can become problematic: if the tanker truck is not sufficiently insulated, the viscosity of the bitumen may increase during an excessively long journey. Bitumen delivery distances are therefore limited. Secondly, maintaining bitumen at high temperatures in tanks or in tanker trucks consumes energy. In addition, maintaining bitumen at high temperatures for a long period of time can affect the properties of the bitumen and thus change the final performance levels of the bituminous mix.

In order to solve this problem, it has been envisioned to disperse the bitumen in the form of an emulsion, the viscosity of which is lower than that of bitumen. However, this emulsifying involves a high water content which is not advantageous for transportation. It is difficult to concentrate the bitumen in emulsions above 80%.

In order to overcome the problems of hot bitumen transportation and storage, packagings allowing bitumen transportation and storage at ambient temperature have been developed. This mode of bitumen transportation by packaging at ambient temperature represents only a minimal fraction of the amounts transported throughout the world, but it corresponds to very real needs for geographical regions which are difficult and expensive to access by the conventional transportation means.

By way of example of packaging allowing the cold transportation currently used, mention may be made of the packaging of the bitumen at ambient temperature in metal drums. This means is increasingly questionable from an environmental point of view because the bitumen stored in the drums must be reheated before it is used as a road binder. However, this operation is difficult to implement for this type of packaging and the drums constitute a waste after use. Furthermore, the storage of bitumen at ambient temperature in drums results in losses because the bitumen is very viscous and a portion of the product remains on the walls of the drum when it is transferred into the tanks of the bituminous mix production units. With regard to the handling and the transportation of bituminous products in these drums, they can prove to be difficult and dangerous if the specialized equipment for handling the drums is not available from the transporters or at the site where the bitumen is used.

By way of other examples of packaging, mention may be made of bitumens in the form of granules transported and/or stored in bags, often used in places where the ambient temperature is high. These granules have the advantage of being easy to handle. U.S. Pat. No. 3,026,568 describes bitumen granules covered with a powdery material, such as limestone powder. Nevertheless, this type of bitumen in granules does not prevent the creep of the bitumen, in particular at high ambient temperature.

Application WO 2009/153324 describes bitumen granules coated with a polymeric anti-agglomerating compound, in particular polyethylene. The drawback of this coating is that it modifies the properties of the bitumen when it is used on roads.

American patent U.S. Pat. No. 5,637,350 describes a bitumen in the form of prills in which the bitumen is encapsulated in a water-impermeable and water-insoluble shell. The bitumen prills are obtained by vaporizing the bitumen in the molten state so as to form drops, and then by coating these drops with a water-impermeable and water-insoluble coating.

Mention may also be made of American patent U.S. Pat. No. 8,404,164 describing a composition of bitumen in the form of solid pellets. These bitumen pellets are obtained by mixing the liquid bitumen with a thickening compound and then a hardening compound, with passage through a granulator. Once in solid form, the bitumen can advantageously be transported at ambient temperature without particular precautions, for example in bags.

An additional difficulty lies in the fact that it is desirable to be able to transport bitumen in solid form even when the outside temperature is very high.

Document WO 2015/104518 describes a process for obtaining a solid bitumen material, which consists in preparing an emulsion of bitumen drops in an aqueous phase stabilized with a mixture of at least two types of solid particles, optionally in forming a shell around the bitumen drops, then in drying the suspension. This process optionally comprises the formation of a silicon oxide-based shell around the bitumen drops, this shell resulting from the reaction of a silicon oxide precursor in an acidic aqueous medium so as to form a gel around the bitumen drops. The pH values used for carrying out this step are generally less than 1, the condensation reaction being promoted by pH values far from the isoelectric point of silica, which is 2.1.

Moreover, American patent application US 2012/0128747 has described a material in the form of solid particles consisting of a continuous shell comprising silicon oxide, containing a core comprising at least one crystallizable oil having a melting point below 100° C. These particles are designed to enable the encapsulation of one or more molecules of interest and the controlled release thereof. Likewise in this document, very low pH values are used to carry out the encapsulation. Moreover, a bitumen composition is much more complex than a crystallizable oil. The extrapolation of operating conditions known to work on the encapsulation of crystallizable oils does not give satisfactory results on all bitumen compositions.

Document JP 2004 091761 describes a bitumen emulsion comprising an emulsifying agent and a colloidal silica, the function of which is to reduce the tacky nature of the bitumen after application. This document does not teach the formation of granules of solid bitumen.

Document U.S. Pat. No. 1,738,776 describes aqueous dispersions of bitumen having improved stability through the addition of a silica gel, which is used in addition to the conventional stabilizers such as clays. This document does not relate to a process for preparing a bitumen material which is solid at ambient temperature.

Document U.S. Pat. No. 5,382,348 describes a process for preparing bitumen granules, this process comprising the spraying of the hot liquid bitumen in the presence of a separating agent which may be silica.

The applicant has observed that, when conditions similar to those taught in the prior art, in particular very acidic conditions, are used on bitumen emulsions stabilized with surfactants, not with solid particles, the bitumen emulsion is destabilized by these operating conditions. These conditions do not make it possible to satisfactorily obtain the formation of a solid bitumen in divided form.

The objective of the invention is to overcome these problems and to provide a process which makes it possible, starting from a bitumen emulsion, to form a silicon oxide-based shell around the bitumen drops, regardless of the nature of the bitumen emulsion.

### SUMMARY OF THE INVENTION

The invention relates to a process for preparing a bitumen material which is solid at ambient temperature, this process comprising at least the steps consisting in:

a) preparing a stabilized emulsion of bitumen drops in an aqueous phase having a pH of from 2 to 4,

b) preparing a silica sol or a silica gel from a first silicon oxide precursor at a pH ranging from 2 to 4,

c) mineralizing the emulsion of bitumen drops from step a), with the silica sol or gel from step b),

d) mineralizing the emulsion of bitumen drops resulting from step c) at a pH of less than or equal to 1 with a second silicon oxide precursor,

e) separating the material from the aqueous phase.

Advantageously, this process relates to the production of bitumen granules which are solid at ambient temperature.

According to one preferred embodiment, the bitumen emulsion from step a) is stabilized with a surfactant or a mixture of surfactants chosen from amphoteric, nonionic and cationic surfactants.

According to a more preferred embodiment, the bitumen emulsion from step a) is stabilized with a cationic surfactant chosen from: a salt of an amine compound chosen from alkylamine salts; polyamine salts; polyamidoamine salts; alkylamidopolyamine salts; alkylpropylenepolyamine salts; imidazoline salts; quaternary ammonium salts; and mixtures thereof.

According to one preferred embodiment, the drops of the bitumen emulsion from step a) have a diameter ranging from 1 μm to 100 μm, preferably from 1 μm to 70 μm, more preferentially from 1 μm to 50 μm.

According to one preferred embodiment, the first and second silicon oxide precursors are chosen from alkoxysilanes, preferably from the group made up of tetraalkoxysilanes; trialkoxysilanes; dialkoxysilanes; and mixtures thereof.

According to one preferred embodiment, the first and second silicon oxide precursors are chosen from the group made up of tetramethoxysilane (TMOS), tetraethoxysilane (TEOS), (3-mercaptopropyl)trim ethoxysilane, (3-aminopropyl)-triethoxysilane, N-(3-trimethoxysilylpropyl)pyrrole, 3-(2,4-dinitrophenylamino)-propyltriethoxysilane, N-(2-aminoethyl)-3-aminopropyltrimethoxysilane, phenyltriethoxysilane, methyltriethoxysilane, dimethyldiethoxysilane (DMDES), and mixtures thereof.

According to one preferred embodiment, in step a), the pH of the aqueous phase is adjusted to a value ranging from 2 to 2.5.

According to one preferred embodiment, in step b), the pH of the aqueous phase is adjusted to a value ranging from 2 to 2.5.

According to one preferred embodiment, in step d), the pH of the aqueous phase is adjusted to a value of less than or equal to 0.5.

According to one preferred embodiment, step e) comprises at least:
a substep e′) consisting in washing and neutralizing the material obtained in e),
a substep e″) consisting in drying the material obtained in e′).

According to one preferred embodiment, in step e″), the drying is carried out by spray-drying, filtration or by freeze-drying.

According to one preferred embodiment, the bitumen from step a) comprises less than 1.4% of solid particles by weight relative to the total weight of bitumen base.

The invention also relates to a solid bitumen material that can be obtained by means of the process described above, this material being in the form of particles comprising a core and a coating layer, in which:
the core comprises at least one bitumen base,
the coating layer is silica-based, and

the core comprises less than 1.4% of solid particles by weight relative to the total weight of bitumen base.

According to one preferred embodiment, the material of the invention is in powder form.

According to one preferred embodiment, the material of the invention comprises from 5% to 35% by weight of silica relative to the total weight of the material, preferably from 5% to 30%, more preferentially from 10% to 25%.

The invention also relates to the use of solid bitumen as described above, as a road binder.

According to one preferred embodiment, the use relates to the production of bituminous mixes.

Another subject of the invention is a process for producing bituminous mixes comprising at least one road binder and aggregates, the road binder being chosen from the solid bitumens as described above, this process comprising at least the steps of:
heating the aggregates to a temperature ranging from 100° C. to 180° C., preferably from 120° C. to 160° C.,
mixing the aggregates with the road binder,
obtaining bituminous mixes.

According to one preferred embodiment, the process does not comprise a step of heating the road binder before it is mixed with the aggregates.

According to one preferred embodiment, said road bitumen is transported and/or stored in the form of bitumen which is solid at ambient temperature as described above.

The process of the invention has many advantages: it is simple to implement, it is applicable to any type of bitumen emulsion, in particular to emulsions stabilized with surfactants and not comprising particles to allow their stabilization, it results, in few steps, in a material which is solid and in the form of finely divided particles, the particle size being adjustable by means of the parameters of the process.

The material obtained by means of the process of the invention has the following advantages: it is thermally stable, in particular at high temperatures, and advantageously for a temperature ranging up to 100° C. The solid bitumen material of the invention does not adhere and has good flowability, which facilitates its handling for loading and/or unloading thereof, during the transportation, storage and/or use thereof. The solid bitumen material according to the invention at high temperature and under mechanical shear can be easily released in liquid form at the working temperatures for said material. The term “working temperature” is intended to mean temperatures of between 100° C. and 180° C., preferably between 120° C. and 160° C., more preferentially between 140° C. and 160° C. The solid bitumen material can thus, once transported, be returned, by heating, to a liquid form suitable for use thereof and the properties of which are not modified. Advantageously, the release of the solid bitumen composition according to the invention is carried out by bringing it into contact with hot aggregates under mechanical shear, without performing prior heating of the solid bitumen composition.

### DETAILED DESCRIPTION

The objectives that the applicant set itself have been achieved by virtue of the development of compositions of bitumen in a divided form, which is solid at ambient temperature, having a core/shell structure in which the core is bitumen-based and the coating layer confers, on the overall structure, improved properties compared with the bitumen granules known from the prior art.

The term “ambient temperature” is intended to mean the temperature resulting from the climatic conditions in which the road bitumen is transported and/or stored. More specifically, the ambient temperature is equivalent to the temperature reached during the transportation and/or storage of the road bitumen, it being understood that the ambient temperature implies that no introduction of heat is carried out, other than that resulting from the climatic conditions.

The invention relates to bitumens that may be subjected to a high ambient temperature, in particular a temperature of less than 100° C., preferably from 20° C. to 80° C.

In the present invention, the term “solid” denotes, at the macroscopic level, the quality of a material having a shape and a specific volume.

The term “bitumen which is solid at ambient temperature” is intended to mean a bitumen which has a solid appearance at ambient temperature regardless of the transportation and/or storage conditions. More specifically, the term “bitumen which is solid at ambient temperature” is intended to mean a bitumen which retains its solid appearance throughout the transportation and/or storage at ambient temperature, that is to say a bitumen which does not creep at ambient temperature under its own weight and, furthermore, which does not creep when it is subjected to pressure forces resulting from the transportation and/or storage conditions.

The term “solid bitumen material” is intended to mean, for example, powders, granules, particles, wafers or granular pastes of bitumen.

For the purposes of the present invention, the term “mineralizing” is intended to mean a treatment with a silica sol or gel under conditions which make it possible to form an at least partial, silicon oxide-based, coating around the bitumen drops in emulsion.

The invention relates firstly to a process for preparing a bitumen material which is solid at ambient temperature, this process using an emulsion of bitumen in the aqueous phase.

The process of the invention comprises firstly the preparation of an emulsion of bitumen in the acidic aqueous phase, so as to form bitumen drops. The process of the invention makes it possible, by reacting a silicon oxide precursor in the acidic aqueous medium, to obtain particles formed from a core comprising bitumen and a shell comprising silicon oxide. The shell is preferably an essentially inorganic shell of silicon oxide.

Contrary to the prior art processes, the formation of the silicon oxide-based shell is carried out in two steps, a first step at a moderately acid pH, then a second step at a more acid pH. The material obtained is then separated from the aqueous phase and dried by means known to those skilled in the art.

These steps are based on a synthesis of silicon oxide via the sol-gel route. This route comprises the preparation of a sol containing at least one silicon oxide precursor, the hydrolysis and the condensation of these precursors under acid catalysis, and then a step of maturation resulting in the formation of a gel.

The two successive steps of mineralizing the bitumen drops with silicon oxide differ in particular in terms of the pH conditions at which they are carried out.

More specifically, these two successive steps of mineralizing the bitumen drops make it possible to form a silicon oxide layer around the bitumen drops.

Without being bound by theory, the applicant has noted that the step of bringing the stabilized bitumen emulsion into contact with the silica sol at moderately acid pH makes it possible to initiate the homogeneous mineralization of the bitumen drops with the silicon oxide.

At the end of the step of bringing into contact, in the moderately acid aqueous phase, the bitumen emulsion and the silica sol or gel previously prepared, a bitumen suspension is obtained.

In the process described below, some steps must imperatively be carried out before other steps, whereas for other steps, the order indicated may be reversed. For example, step a) can be carried out after step b), or extemporaneously with the performing of step b).

Step a): The Emulsion of Bitumen in the Aqueous Phase

During step a) of the process according to the invention, a stabilized emulsion of bitumen drops in an aqueous phase having a pH ranging from 2 to 4 is prepared.

Bitumen is a heavy product which can come from various origins. In the present invention, the expression “bitumen” comprises bitumens of natural origin, synthetic bitumens and modified bitumens, and also mixtures thereof. Among bitumens of natural origin, mention may be made of those contained in natural bitumen deposits, natural asphalt deposits or tar sands. Synthetic bitumens can be selected from bitumens originating from crude oil refining, for example during atmospheric and/or vacuum distillation of oil. These bitumens can optionally be blown, visbroken and/or deasphalted. Synthetic bitumens can also be obtained by mixing various refining effluents, such as deasphalting products, visbreaking residues, blowing products and/or natural asphalt, by optionally combining them with the above distillation residues. Bitumens may be hard grade bitumens or soft grade bitumens. It is also known practice to modify the bitumen (or the bitumen mixture) by mixing therewith at least one compound for the purpose of improving some of its mechanical and thermal performance levels. The modified bitumens may be bitumens that have been fluxed by addition of volatile solvents, or fluxing agents of oil origin and/or fluxing agents of plant origin. Conventionally, the fluxing agents used can comprise C₆ to C₂₄ fatty acids in acid, ester or amide form in combination with a hydrocarbon-based fraction. The modified bitumens may also be bitumen/polymer mixtures. By way of examples of polymers for bitumen, mention may be made of elastomers such as the copolymers SB (copolymer comprising styrene and butadiene blocks), SBS (styrene-butadiene-styrene block copolymer), SIS (styrene-isoprene-styrene copolymer), SBS* (star-shaped styrene-butadiene-styrene block copolymer), SBR (styrene-butadiene-rubber copolymer) or EPDM (ethylene-propylene-diene modified copolymer), polychloroprene, polynorbornene and optionally polyolefins such as polyethylenes PE (polyethylene) or PP (polypropylene), plastomers such as EVA (polyethylene-vinyl acetate copolymer) or EMA (polyethylene-methyl acrylate copolymer), copolymers of olefins and of unsaturated carboxylic esters, such as EBA (polyethylene-butyl acrylate copolymer), polyolefin elastomer copolymers, polyolefins of the polybutene type, copolymers of ethylene and of acrylic, methacrylic acid esters or of maleic anhydride, copolymers and terpolymers of ethylene and of glycidyl methacrylate, ethylene-propylene copolymers, rubbers, polyisobutylenes, SEBS (copolymer of styrene, of ethylene, of butylene and of styrene), ABS (acrylonitrile-butadiene-styrene). Other additives may be added in order to modify the mechanical characteristics of a bitumen. These are for example vulcanizing agents and/or crosslinking agents capable of reacting with a polymer, when it is an elastomer and/or a plastomer, that can be functionalized and/or can comprise reactive sites.

Among the vulcanizing agents, mention may be made of those based on sulfur and derivatives thereof, used to crosslink an elastomer at contents of from 0.01% to 30% by weight relative to the weight of elastomer. Among the crosslinking agents, mention may be made of cationic crosslinking agents such as carboxylic monoacids or polyacids or anhydrides, carboxylic acid esters, sulfonic, sulfuric or phosphoric acids, or even acid chlorides, or phenols, at contents of from 0.01% to 30% by weight relative to the weight of the polymer.

These agents are capable of reacting with the functionalized elastomer and/or plastomer. They can be used in addition to or as a replacement for the vulcanizing agents. Among the additives that can be used, mention will be made of additives known to those skilled in the art, such as siccatives capable of ensuring increased cohesion over time of the fluxed binder and additives which make it possible to emulsify the bitumen.

Mention will also be made of adhesion agents such as amines or polyamines and/or surfactants; waxes of animal, plant or hydrocarbon-based origin; paraffins such as polymethylene paraffins and polyethylene paraffins; fluxing agents such as oils based on animal and/or plant fats or hydrocarbon-based oils of petroleum origin; resins of plant origin, such as rosins; antifoam additives; detergent and/or anti-corrosion additives; lubrication additives or anti-wear agents; crystallization-modifying additives; additives which inhibit paraffin deposits; additives which lower the pour point; modifiers of the rheology at low temperature; antioxidants; metal passivators; acidity neutralizers; additives which make it possible to lower the mixing temperature of asphalts and bituminous mixes; additives which make it possible to improve the adhesion of bituminous binders to fillers and granules, such as polyisobutylene succinim ides; acids such as polyphosphoric acid or diacids, in particular fatty diacids; vulcanization accelerators such as zinc 2-mercaptobenzothiazole, zinc dibutyldithiocarbamate or tetramethylthiuram monosulfide.

The preparation of an emulsion of bitumen in an aqueous phase has already been described in the prior art.

According to one preferred embodiment of the process of the invention, the bitumen emulsion is stabilized with surfactants.

Depending on the bitumen to be emulsified and on the surfactant(s) chosen, those skilled in the art, with their general knowledge, are able to determine the pH of the aqueous phase of the bitumen emulsion making it possible to obtain an emulsion of bitumen drops which is stabilized with surfactants.

This type of emulsion has already been described in the prior art. For example, WO 2009/144544 or Boucard & al., Road Materials and Pavement Design (2015, 16(1), p. 330-348) describes the preparation of a bitumen emulsion stabilized with a surfactant in aqueous solution, in particular in acidic aqueous solution.

According to one preferred embodiment of the process of the invention, step a) comprises at least:
a substep a′) consisting in preparing an emulsion of bitumen drops in an aqueous phase stabilized with surfactants,
a substep a″) consisting in adding an additional amount of surfactants to the bitumen emulsion prepared in substep a′).

Preferably, the surfactants added in step a″) are in acidic aqueous solution.

The addition of an additional amount of surfactant in substep a″) makes it possible to aggregate the bitumen drops obtained in substep a′) with one another in order to control the size of the aggregates of bitumen drops in emulsion.

The surfactants used for preparing the emulsion of bitumen drops are preferably chosen from amphoteric, nonionic and cationic surfactants, and also mixtures thereof.

The cationic surfactants are advantageously salts of amine compounds chosen from alkylamine salts; polyamine salts; polyamidoamine salts; alkylamidopolyamine salts; alkylpropylenepolyamine salts such as N-tallow propylenepolyamine salts; imidazoline salts; quaternary ammonium salts such as alkyltrimethylammonium salts, for instance tetradecyltrimethylammonium bromide (TTAB), or alkylbenzyldimethyl-ammonium salts; and mixtures thereof.

Advantageously, the cationic surfactant is tetradecyltrimethylammonium bromide (TTAB).

The amphoteric surfactants are advantageously chosen from alkyl amino acids or betaines.

The nonionic surfactants are advantageously ethoxylated alkylphenols.

The amount of surfactant used in this step can range from 0.1% to 10% by weight relative to the total weight of the emulsion, preferably from 0.3% to 8%, more preferentially from 2% to 7%.

Preferably, the amount of surfactant is from 0.5% to 30% by weight relative to the weight of bitumen base, even more preferentially from 0.5% to 20%, more preferentially from 1% to 10%.

Preferably, according to this embodiment, the bitumen emulsion comprises little or no solid particles enabling stabilization of the emulsion, whether they are mineral or organic particles. In particular, preference is given to emulsions of bitumen in an aqueous phase which comprise less than 1.4% by weight of solid particles, relative to the total weight of bitumen base, even more preferentially less than 1.2%, better still less than 1%, and even more preferentially less than 0.5% by weight of solid particles, relative to the total weight of bitumen base.

According to another embodiment of the invention, the emulsion of bitumen in an aqueous phase is stabilized with solid particles. This type of emulsion, commonly known as “Pickering emulsion”, has already been described in the prior art. For example, patent application FR 2 852 964 describes the preparation of a bitumen emulsion by means of a solid mineral material having a particle size ranging from 10 nm to 5 μm. International application WO 2015/104518 describes a solid bitumen emulsion stabilized with a mixture of at least two types of solid particles.

According to this embodiment, the particles used may be mineral or organic particles. Among the mineral particles, the solid particles are preferably chosen from the group made up of particles of oxides, particles of hydroxides and particles of sulfates of silicon or of metals. More preferentially, the solid particles are chosen from the group made up of particles of silicon oxide, titanium oxide, zirconium oxide and iron oxide, and salts thereof such as silicates, and carbon particles. Among the organic particles, mention may in particular be made of polymeric particles, for example latex or cellulose particles, lignin particles.

Furthermore, according to one preferred embodiment, at least one surfactant compound is added to the aqueous medium before the reaction of the emulsion of bitumen drops with the silica sol or gel. The surfactant compound may be as defined above in step a). The concentration of surfactant compound in the medium may be between 0.5% and 30% by weight relative to the weight of bitumen base, even more preferentially from 0.5% to 20%, more preferentially from 1% to 10%.

The acidic aqueous phase of the bitumen emulsion in step a) is obtained by adding a strong acid, for example hydrochloric acid. The amount of acid added is calculated such that the pH of the medium is preferentially from 2 to 4, more preferentially from 2 to 3, even more preferentially from 2 to 2.5. Contrary to the prior art processes, in which the pH was adjusted to a very low value, in the region of 0.2, in the process of the invention, the aqueous phase of the bitumen emulsion is acidified to a higher pH, in particular to a pH greater than or equal to the isoelectric point of silica, that is to say greater than or equal to 2.1.

This is because the applicant has noted that acidification of the emulsion of bitumen drops from step a) to a pH of less than 2 leads to a destabilization of the aqueous bitumen emulsion and does not allow the formation of a composition of bitumen which is solid at ambient temperature, in divided form, with a core-shell structure having satisfactory working properties, when the bitumen emulsion is essentially stabilized with surfactants and not with particles.

In the process according to the invention, step a) which consists in preparing a stabilized emulsion of bitumen drops in an acidic aqueous phase, in particular an aqueous phase having a pH ranging from 2 to 4, can be carried out by emulsifying, by means of mechanical stirring, an aqueous mixture comprising the acidic aqueous solution to which surfactants and the bitumen have been added. The mechanical stirring devices well known to those skilled in the art, such as Emulbitume® and Atomix®, can be used. The bitumen can be preheated in order to reduce its viscosity, preferably at a temperature of between 100° C. and 180° C., preferably between 120° C. and 160° C., and more preferably between 140° C. and 160° C. An aqueous mixture comprising the acidic aqueous phase to which surfactants and bitumen have been added can be obtained by pouring the hot bitumen into an acidic aqueous composition comprising the emulsifying and stabilizing materials, in particular the surfactants. Preferably, the aqueous composition is preheated at a temperature of between 30° C. and 95° C. in order to prevent the liquid bitumen from immediately solidifying on contact with the aqueous phase.

At the end of this step a), a stabilized emulsion of bitumen drops in an acidic aqueous phase, in particular an aqueous phase having a pH ranging from 2 to 4, is obtained. These drops can have a diameter ranging from 1 μm to 100 μm, preferably from 1 μm to 70 μm, more preferentially from 1 μm to 50 μm. The size of the solid bitumen particles can be adjusted in a manner known to those skilled in the art according to the desired size of the bitumen drops, in particular by adding surfactants and/or by stirring the emulsion so as to promote agglomeration of the drops.

The emulsion can have a weight content of bitumen ranging from 1% to 90% by weight, preferably from 10% to 80% by weight, and more preferably from 20% to 70% by weight, relative to the total weight of the emulsion.

The stabilized emulsion of bitumen drops obtained in step a) can be used as it is directly in step c).

Step b): Preparation of a Silica Sol or a Silica Gel

The first silicon oxide precursor can be chosen from alkoxysilanes, preferably from the group made up of:
tetraalkoxysilanes, for example tetramethoxysilane (TMOS) and tetraethoxysilane (TEOS);
trialkoxysilanes, for example (3-mercaptopropyl)trimethoxysilane, (3-amino-propyl)triethoxysilane, N-(3-trimethoxysilylpropyl)pyrrole, 3-(2,4-dinitrophenyl-amino)propyltriethoxysilane, N-(2-aminoethyl)-3-aminopropyltrimethoxysilane, phenyltriethoxysilane and methyltriethoxysilane;
dialkoxysilanes, for example dimethyldiethoxysilane (DMDES);
and mixtures thereof.

Preferably, the silicon oxide precursor can be chosen from the group made up of tetramethoxysilane (TMOS), tetraethoxysilane (TEOS), (3-m ercapto-propyl)trimethoxysilane, (3-aminopropyl)triethoxysilane, N-(3-trimethoxysilyl-propyl)pyrrole, 3-(2,4-dinitrophenylamino)propyltriethoxysilane, N-(2-aminoethyl)-3-aminopropyltrimethoxysilane, phenyltriethoxysilane, methyltriethoxysilane, dimethyldiethoxysilane (DMDES), and mixtures thereof.

The silicon oxide precursor is advantageously TEOS.

The silica sol or gel is advantageously prepared by using from 5% to 25% by weight of silicon oxide precursor relative to the sum of the weights of the water and of the precursor.

The silica sol or gel is advantageously prepared by introducing the silicon oxide precursor into a water at pH ranging from 2 to 4, advantageously from 2 to 2.5.

The mixture of water and silicon oxide precursor is then stirred until a homogeneous phase is obtained. During the mixing of water and silicon oxide precursor, the precursor is subjected to acid hydrolysis; a hydrolysis residue, ethanol in the case of TEOS, forms and evaporates off by stirring of the mixture in an open system. Advantageously, the mixture is left to stir until complete or virtually complete evaporation of the hydrolysis residue, and in particular of the ethanol. The reaction of the silicon oxide precursor in acidic aqueous medium allows the formation of a sol which converts into a gel by maturation.

Step c): Mixing of the Silica Sol or Gel and of the Aqueous Bitumen Emulsion

During this step c), the amounts of silica sol or gel and of aqueous bitumen emulsion are chosen such that the weight ratio between bitumen and the amount of silicon oxide precursor(s) (used in step b)) is between 1 and 20, more preferably between 1 and 10.

Preferably, the amount of silica sol or gel used in step c), calculated in silicon oxide precursor(s) equivalent, is from 5% to 40% by weight of silicon oxide precursor(s) relative to the weight of bitumen, more preferentially from 10% to 30%.

The mixture is left to stir, preferably for between 1 h and 48 h, more preferentially between 1 h and 24 h.

In order to promote the homogeneity of the reaction medium, stirring is preferably applied during step (c). This stirring is preferably mild but continuous and is not carried out by means of a blade, a magnetic bar, etc. The reaction medium can for example be placed in a rotary stirrer, in particular of roll or wheel type. For example, the stirring can be carried out by rolls having a diameter of 3 cm at a speed of between 5 and 50 rpm, preferably between 10 and 30 rpm.

Step d): Mineralization of the Emulsion of Bitumen Drops Resulting from Step c) at a pH of Less than or Equal to 1 with a Second Silicon Oxide Precursor

During step d), the aqueous phase of the bitumen emulsion is acidified, by adding a strong acid, for example hydrochloric acid. The amount of acid added is calculated such that the pH of the medium is less than or equal to 1, preferably less than or equal to 0.5.

Contrary to the emulsion of bitumen drops from step a), the emulsion obtained at the end of step c) is not destabilized by an acid medium having a pH of less than or equal to 1. This pH promotes the formation of a very rigid shell of silicon oxide around the bitumen drops.

The second silicon oxide precursor is chosen in a known manner from alkoxysilanes, as in step b). Preferentially, the same silicon oxide precursor as in step b) is chosen.

Preferably, the operating conditions are chosen so as to promote the formation of a continuous layer of silicon oxide coating.

During this step d), the amounts of silicon oxide precursor and of aqueous bitumen emulsion are chosen such that the weight ratio between the bitumen and the amount of silicon oxide precursor(s) (used in step d)) is between 1 and 5, more preferably between 1 and 3.

Preferably, the amount of silicon oxide precursor(s) in step d) is from 20% to 60% by weight relative to the weight of bitumen, more preferentially from 30% to 50%.

The mixture is left to stir, preferably for between 1 h and 24 h, more preferentially between 1 h and 16 h.

In order to promote the homogeneity of the reaction medium, stirring is preferably applied during step (d). This stirring is preferably mild but continuous and is not carried out by means of a blade, a magnetic bar, etc. The reaction medium can for example be placed in a rotary stirrer. For example, the stirring can be carried out by means of rolls having a diameter of 3 cm at a speed of between 5 and 50 rpm, preferably between 10 and 30 rpm.

At the end of step d), particles with a core/shell structure comprising a bitumen base core and a silicon oxide shell are formed. Particles formed from a core comprising bitumen and from an essentially inorganic shell, in suspension in the aqueous medium, are obtained.

If it is desired to obtain a thicker silicon oxide shell, step d) can be repeated one or more times.

At the end of step d), a bitumen suspension is obtained.

Step e): Separation of the Material from the Aqueous Phase

Step e) of the process according to the invention advantageously comprises a substep e′) consisting in washing the material obtained in d), followed by a substep e″) consisting in drying the material obtained in e′) until a solid bitumen material is obtained.

The washing is carried out in a manner known to those skilled in the art by means of a substantially neutral aqueous solution, so as to extract, with water, the acid and the residue from formation of the silica sol (ethanol in the case where TEOS is used as silicon oxide precursor). The separation of the aqueous phase can be carried out by any known means, such as centrifugation, filtration, sieving.

Advantageously, the washing is continued until the pH of the aqueous washing phase has been adjusted to a value of greater than or equal to 4.5, preferably approximately 5. This treatment makes it possible to substantially neutralize the acidic nature of the emulsion resulting from step d).

The drying method can be chosen from the conventional methods well known to those skilled in the art. For example, the solid material can be recovered from the aqueous medium by vacuum filtration on a Büchner funnel, then dried in a desiccator. Alternatively, the material can be dried in the air, by freeze-drying or by spray-drying.

This spray-drying technique makes it possible to reduce the capillary forces applied, which may break the shell of the solid bitumen particles.

The drying of step e″) may be complete or partial. Preferably, the drying is substantially complete drying, that is to say that the moisture content of the solid particles obtained at the end of step e″) is less than or equal to 5% by weight relative to the total weight of the particles, even more preferentially less than or equal to 2% by weight relative to the total weight of the particles.

In a first preferred embodiment, the material is spray-dried. This technique is advantageous insofar as it makes it possible to reduce the capillary forces applied, that may break the envelope or the shell of the solid bitumen particles. This technique is conventionally used to obtain powders in the food-processing, pharmaceutical and cosmetic field.

According to a second preferred embodiment, the material is dried by freeze-drying.

The drying techniques according to the first or second embodiment both have the advantage of providing a dried bitumen powder with good properties in terms of adhesiveness, thermal resistance and mechanical strength, and which is in the form of a very fine granular powder.

Solid Bitumen Material

The solid bitumen material obtained or capable of being obtained by means of the process described above is also a subject of the present invention. Indeed, when the bitumen emulsion is an emulsion stabilized with surfactants, it comprises no, or substantially no, particles for stabilization thereof. The prior art processes for mineralizing in a step at very acid pH do not make it possible to form particles comprising a bitumen core and a silica-based shell. This material is advantageous insofar as it constitutes a new solid form of bitumen. This material is a solid bitumen material comprising particles formed from a core comprising bitumen and a shell.

This embodiment relates to bitumen-based core/shell particles coated with a silica-based shell or envelope, which comprise, in the bitumen base, less than 1.4% by weight of solid particles relative to the total weight of bitumen base, even more preferentially at most 1.2%, better still at most 1%, and even more preferentially at most 0.5% by weight of solid particles relative to the total weight of bitumen base.

The term “shell” is intended to mean a layer at least partially surrounding the bitumen core and comprising a homogeneous layer of silicon oxide obtained by mineralization according to steps c) and d) of the process as described above.

Preferably, the term “shell” is intended to mean a layer at least partially surrounding the bitumen core and consisting of a homogeneous layer of silicon oxide obtained by mineralization according to steps c) and d) of the process as described above.

The term “layer or shell at least partially surrounding the bitumen core” is intended to mean a layer surrounding at least 90% of the surface of the core, preferably at least 95% of the surface of the core, more preferentially at least 99% of the surface of the core.

It is possible to distinguish a solid bitumen material comprising a shell owing to the distinctive particular appearance of the shell (homogeneous layer) using conventional analysis methods known to those skilled in the art, for example by electron microscopy.

Advantageously, the silicon oxide-based shell represents from 5% to 35% by weight relative to the total weight of the solid bitumen material obtained at the end of step e), preferentially from 5% to 30%, more preferentially from 10% to 25%. The low silica content of the materials of the invention makes it possible to prepare road bitumens by mixing with aggregates, the properties of which are barely affected by the presence of the silica.

The material of the invention is in powder form, optionally in aggregated powder form, preferably in fluid powder form. Preferably, the size of the particles or grains of powder is from 1 to 500 μm, even more advantageously from 5 to 300 μm, even better still from 10 to 200 μm. In a known manner, the size of the particles or grains of powder is evaluated by scanning electron microscopy (SEM) or by laser particle size analysis.

The residual moisture content in the material of the invention is preferably less than or equal to 5% by weight, even better still less than or equal to 3% by weight, and even more preferably less than or equal to 1% by weight, relative to the total weight of the material.

The solid bitumen material obtained, or capable of being obtained, by means of the process according to the invention is particularly advantageous since it has excellent thermal stability, up to high temperatures. The term “thermal stability” is intended to mean the fact that the bitumen material retains its solid structure in powder form and does not adhere up to a temperature of less than or equal to 100° C., preferably less than or equal to 120° C., even better still up to a temperature of less than or equal to 150° C.

The solid bitumen material obtained or capable of being obtained by means of the process according to the invention is particularly advantageous since it has excellent compressive strength.

These properties make it possible to envision transporting this powdered bitumen in bags, in particular bags of a size greater than or equal to 100 kg, even better still of a size greater than or equal to 1000 kg, these bags being commonly known as “big bags”, in boxes of from 5 kg to 30 kg, or in drums of from 100 kg to 200 kg.

In addition, the tests have shown that the solid bitumen material according to the invention can be readily releasable at the time of the production of bituminous binder. It can therefore be used after its transportation in a conventional manner, without the need to adapt the processes using this material. The uses of this bitumen can for example be in the road application fields, in particular in the production of road binders such as hot bituminous mixes, cold bituminous mixes or surface coatings, and in the industrial application fields, for example in the production of internal or external coatings.

Uses of the Solid Bitumen Material:

Another subject of the invention also relates to the use of the bitumen material which is solid at ambient temperature according to the invention as a road binder.

The road binder can be used to produce bituminous mixes, in combination with aggregates according to any known process.

Preferably, the bitumen which is solid at ambient temperature according to the invention is used for the production of bituminous mixes.

Bituminous mixes are used as materials for constructing and maintaining road foundations and the surfacing thereof, and also for carrying out any highway work. Mention may for example be made of surface coatings, hot bituminous mixes, cold bituminous mixes, cold-poured bituminous mixes, emulsion gravels, base layers, bonding layers, tie layers and running layers, and other combinations of a bituminous binder and of the road aggregate having particular properties, such as anti-rutting layers, draining mixes, or asphalts (mixture of a bituminous binder and aggregates of the sand type).

Another subject of the invention relates to a process for producing bituminous mixes comprising at least one road binder and aggregates, the road binder being chosen from the solid bitumens according to the invention, this process comprising at least the steps of:
heating the aggregates to a temperature ranging from 100° C. to 180° C., preferably from 120° C. to 160° C.,
mixing the aggregates with the road binder in a tank such as a mixer or a mixing drum,
obtaining bituminous mixes.

The process of the invention has the advantage of being able to be carried out without a prior step of heating the solid bitumen according to the invention.

The process for producing bituminous mixes according to the invention does not require a step of heating the solid bitumen material before mixing with the aggregates, since, in contact with the hot aggregates and under a mechanic shear effect, the bitumen which is solid at ambient temperature is released.

The bitumen which is solid at ambient temperature according to the invention as described above has the advantage of being able to be added directly to hot aggregates, without having to be melted prior to the mixing with the hot aggregates.

Preferably, the step of mixing the aggregates and the road binder is carried out with stirring, then the stirring is maintained for at most 5 minutes, preferably at most 1 minute, in order to make it possible to obtain a homogeneous mixture.

The bitumen material which is solid at ambient temperature according to the present invention is notable in that it enables the transportation and/or storage of road bitumen at ambient temperature under optimal conditions, in particular without there being any agglomeration and/or adhesion of the solid bitumen during its transportation and/or storage, even when the ambient temperature is high. Moreover, the coating layer of the particles breaks under the effect of the contact with the hot aggregates and the mechanical shear, and it releases the bitumen base. Finally, the presence of the coating layer in the mixture of road binder and aggregates does not degrade the properties of said road bitumen for a road application, compared with a base of the same bitumen which is uncoated.

Process for Transporting and/or Storing and/or Handling Road Bitumen

Another subject of the invention also relates to a process for transporting and/or storing and/or handling road bitumen, said road bitumen being transported and/or stored and/or handled in the form of bitumen particles which are solid at ambient temperature.

Preferably, the road bitumen is transported and/or stored at a high ambient temperature for a period of greater than or equal to 2 months, preferably greater than or equal to 3 months.

Preferably, the high ambient temperature is from 20° C. to 90° C., preferably from 20° C. to 80° C., more preferentially from 40° C. to 80° C., even more preferentially from 40° C. to 60° C.

The bitumen particles according to the invention have the advantage of retaining their divided form, and therefore of being able to be handled, after storage and/or transportation, at a high ambient temperature. They in particular have the capacity to flow under their own weight without sticking to one another, which allows them to be stored in bag packaging, drum packaging or container packaging of any shapes and of any volumes, then to be transferred from this packaging to equipment, such as worksite equipment (tank, mixer, etc.).

The bitumen granules are preferably transported and/or stored in bulk in bags of 1 kg to 100 kg or 500 kg to 1000 kg commonly known as “Big Bags” in the road bitumen field, said bags preferably being made of a hot-melt material. They may also be transported and/or stored in bulk in boxes of 5 kg to 30 kg or in drums of 100 kg to 200 kg.

The various embodiments and variants, the preferences and the advantages described above for each of the subjects of the invention apply to all the subjects of the invention and can be taken separately or in combination.

Other objectives, features and advantages of the invention will emerge from the following examples, which are given purely by way of illustration and are in no way limiting.

### EXPERIMENTAL SECTION

### I—Materials and Methods

Paraffinic bitumen base of grade 160/220

Surfactant: tetradecyltrimethylammonium bromide (TTAB) sold by the company Sigma Aldrich

Acid: the pH of the water was adjusted by means of hydrochloric acid in the form of an aqueous solution at 37% by volume

Silica precursor: tetraethoxysilane (TEOS) sold by the company Sigma Aldrich

### II—Examples

Step a) Preparation of an Emulsion of Bitumen Drops in an Aqueous Phase:

The bitumen-in-water emulsion was prepared with an Emulbitume® colloidal mill. The apparatus is composed of two thermostatic containers; one for the aqueous phase at 40° C. and the other for the bitumen at 130° C. Two distinct circuits bring the phases to the Atomix® mixer in which the bitumen is dispersed in the aqueous phase. The flow rates are controlled so as to obtain an emulsion with a bitumen content of 68% by weight. A surfactant (TTAB) concentration of 4 kg/tonne of emulsion was added to the bitumen emulsion previously obtained.

0.7 g of TTAB dissolved beforehand in 6.3 g of water at pH 2.33 was then added to 9 g of the bitumen emulsion previously obtained. The whole mixture is transferred into a 15 ml tube which is then placed in a rotary device (wheel) at 20 rpm overnight.

The following composition is obtained:

| Starting material | Bitumen base | TTAB | Water |
|---|---|---|---|
| % by weight | 38.25 | 5.01 | 56.76 |

Step b) Preparation of a Silica Sol or Gel from a Silicon Oxide Precursor:

0.8 ml of the silica precursor (TEOS) is added dropwise to 5 g of an aqueous solution at pH=2.3 with magnetic stirring at 500 rpm, the stirring being stopped when a single phase is obtained.

The following composition is obtained:

| Starting material | TEOS | Water (pH = 2.3) |
|---|---|---|
| % by weight | 12.95 | 87.05 |

Step c) Mixing of the Emulsion of Bitumen Drops from Step a), with the Silica Sol or Gel from Step b):

9 g of the emulsion from step a) were weighed into a beaker and the prehydrolyzed solution from step b) was added thereto dropwise, the whole mixture having been transferred into a 15 ml tube. In order to avoid any loss, 2 g of water at pH=2.3 were poured into the beaker in order to rinse it. The tube was then placed on the wheel at 20 rpm for 3 days. The composition of the tube is the following:

| Starting | | | | |
|---|---|---|---|---|
| material | Bitumen base | TTAB | TEOS | Water |
| % by weight | 20.56 | 2.67 | 4.45 | 72.32 |

This step allows a first mineralization at pH=2.3 while at the same time avoiding destabilization of the bitumen suspension and thus makes it possible to initiate the homogeneous mineralization of the bitumen drops with the silicon oxide.

Step d) Mineralization of the Emulsion of Bitumen Drops Resulting from Step c) at Acid pH with a Silicon Oxide Precursor:

23 g of demineralized water and 21 g of hydrochloric acid at 37% by volume were mixed, in a flask, in order to obtain a solution at a pH of 0.2 (optimal pH for the mineralization). The mineralized solution (solution after 1^{st} condensation) was then poured into the flask, then 1.6 ml of TEOS were added dropwise. The whole mixture was transferred into a 50 ml tube which was placed on the wheel at 20 rpm for one day. The composition of the tube is the following:

| | | | | Hydrochloric | Water | |
|---|---|---|---|---|---|---|
| Starting | Bitumen | | | acid at 37% | pH = | Demineralized |
| material | base | TTAB | TEOS | by volume | 2.3 | water |
| % by | 5.53 | 0.72 | 3.59 | 33.75 | 16.94 | 39.47 |
| weight | | | | | | |

At the end of step d), a suspension of bitumen particles is obtained.

Step e) Separation of the Material from the Aqueous Phase:

After 24 h, the 2nd mineralization is considered to be complete and the suspension of bitumen particles obtained in step d) is washed with water by centrifugation in order to remove all the acid and the ethanol and to obtain a final suspension with a pH at around 5. For this, the 50 ml tubes are placed in a centrifuge at 7000 rpm for 10 min. At the end of the cycle, the supernatant (aqueous phase) is removed and replaced with demineralized water. The capsules are redispersed by manual stirring and a further centrifugation cycle is initiated until the pH of the solution is close to 5.

The drying was carried out by freeze-drying. The frozen samples were placed in plastic sample holders at −80° C. overnight, then the following day in the freeze-dryer for a 24 h cycle. The water in the form of ice moves into the gas state and the completely dry bitumen powder is recovered.

### III—Results

Macroscopic and Microscopic Observations:

During the 2 mineralizations, there was no loss of bitumen. Furthermore, by virtue of the freeze-drying technique, a very fine granular powder is obtained.

The powder was then characterized by scanning electron microscopy (SEM). The obtaining of grains with sizes between 20 and 100 μm is observed. Furthermore, the images make it possible to observe the presence of a thin layer of silica at the surface of the external drops of the grains.

Silica Content: Thermogravimetric Analysis and Elemental Analysis

The thermogravimetric analysis (TGA) shows that the powder contains 15.6% by weight of silica. An elemental chemical analysis confirmed that the silica content was about 15-16% by weight.

Thermal Resistance and Mechanical Strength

Thermal and Shear Test:

The powder was tested with regard to the temperature resistance and also the shear resistance. For this, the sample was placed in an aluminum dish, itself placed in an oven. Various temperatures were tested: 90° C., 120° C. and 150° C. The powder showed good temperature resistance since no grain adhered to the aluminum dish, indicating that no release of bitumen had occurred.

With regard to the shear resistance tests and in order to better imitate the coating process, the powder was heated to 150° C. and was then crushed using a pestle. The result is very conclusive since all the bitumen was released. This result is interesting since the objective is for the powders to withstand transportation, but it is necessary for them, under mechanical shear and at working temperatures, to release the bitumen which is in the core of the particles.

Powder Compression Test:

In order to quantify the compressive strength of the powders in a big bag, under extreme storage conditions, the following protocol was applied: the crucible was filled and then a compressive force of ˜8.1 kPa (which represents the force applied in a 1 tonne big bag) was applied to the powder at a temperature of 90° C. for several hours and the sample was then observed after compression.

It is first of all noted that the indenting device does not show any adhered bitumen. Furthermore, the compressed sample can be easily removed from the crucible and the powder recovered easily returns to granular form.

Powder Compression Test:

A second test was carried out according to the technique described below: the powder was placed in a completely closed syringe and a 1 kg weight was placed on the plunger (equivalent to 31 kPa of pressure applied). The whole assembly was placed in an oven at 50° C. After 3 h of experiment, the powder was removed from the syringe and it was possible to note that said powder withstood the compression. Indeed, there is little loss on the syringe and the powder recovered returns easily to granular form.

Coating and Passive Adhesiveness Test

Coating:

40.08 g of diorite aggregates were weighed and placed in a bowl in an oven at 160° C. 2.35 g of powder were then weighed and placed in an oven at 60° C. Once the 2 constituents were at temperature, the powder was poured onto the aggregates and manual shearing with a spatula was applied. The bowl was placed in an oven at 160° C. and further shearing was applied until coated aggregates were obtained.

Passive Adhesiveness:

The coated aggregates were placed in water at 60° C. overnight. The result is very satisfactory since the bitumen did not withdraw from the aggregates.

1-15. (canceled)

16. A process for preparing a bitumen material which is solid at ambient temperature, this process comprising at least the steps consisting in:
a) preparing a stabilized emulsion of bitumen drops in an aqueous phase having a pH of from 2 to 4,
b) preparing a silica sol or a silica gel from a first silicon oxide precursor at a pH ranging from 2 to 4,
c) mineralizing the emulsion of bitumen drops from step a), with the silica sol or gel from step b),
d) mineralizing the emulsion of bitumen drops resulting from step c) at a pH of less than or equal to 1 with a second silicon oxide precursor,
e) separating the material from the aqueous phase.

17. The process as claimed in claim 16, wherein the bitumen emulsion from step a) is stabilized with a surfactant or a mixture of surfactants chosen from amphoteric, nonionic and cationic surfactants.

18. The process as claimed in claim 17, wherein the bitumen emulsion from step a) is stabilized with a cationic surfactant chosen from: a salt of an amine compound chosen from alkylamine salts; polyamine salts; polyamidoamine salts; alkylamidopolyamine salts; alkylpropylenepolyamine salts; imidazoline salts; quaternary ammonium salts; and mixtures thereof.

19. The process as claimed in claim 16, wherein the drops of the bitumen emulsion from step a) have a diameter ranging from 1 μm to 100 μm.

20. The process as claimed in claim 16, wherein the first and second silicon oxide precursors are chosen from alkoxysilanes.

21. The process as claimed in claim 20, wherein the first and second silicon oxide precursors are chosen from the group made up of tetraalkoxysilanes; trialkoxysilanes; dialkoxysilanes; and mixtures thereof.

22. The process as claimed in claim 21, wherein the first and second silicon oxide precursors are chosen from the group made up of tetramethoxysilane (TMOS), tetraethoxysilane (TEOS), (3-mercaptopropyl)trimethoxysilane, (3-aminopropyl)-triethoxysilane, N-(3-trimethoxysilylpropyl)pyrrole, 3-(2,4-dinitrophenylamino)-propyltriethoxysilane, N-(2-aminoethyl)-3-aminopropyltrimethoxysilane, phenyltriethoxysilane, methyltriethoxysilane, dimethyldiethoxysilane (DMDES), and mixtures thereof.

23. The process as claimed in claim 16, wherein, in step a), the pH of the aqueous phase is adjusted to a value ranging from 2 to 2.5.

24. The process as claimed in claim 16, wherein, in step b), the pH of the aqueous phase is adjusted to a value ranging from 2 to 2.5.

25. The process as claimed in claim 16, wherein, in step d), the pH of the aqueous phase is adjusted to a value of less than or equal to 0.5.

26. The process as claimed in claim 16, wherein step e) comprises at least:
a substep e′) consisting in washing and neutralizing the material obtained in e),
a substep e″) consisting in drying the material obtained in e′).

27. The process as claimed in claim 25, wherein, in step e″), the drying is carried out by spray-drying, filtration or by freeze-drying.

28. The process as claimed in claim 16, wherein the bitumen from step a) comprises less than 1.4% of solid particles by weight relative to the total weight of bitumen base.

29. The process as claimed in claim 16, wherein the bitumen material which is solid at ambient temperature comprises particles formed from a core comprising bitumen coated with a silica-based shell.

30. The process as claimed in claim 29, wherein the silicon oxide-based shell represents from 5% to 35% by weight relative to the total weight of the solid bitumen material obtained at the end of step e).

31. A process for producing bituminous mixes, which comprises:
the production of particles of solid bitumen by means of the process as claimed in claim 16,
mixing the particles of solid bitumen with aggregates.

32. The process for producing bituminous mixes comprising at least one road binder and aggregates, as claimed in claim 31, this process comprising at least the steps of:
producing a road binder, consisting of particles of solid bitumen, this process comprising at least the steps consisting in:
a) preparing a stabilized emulsion of bitumen drops in an aqueous phase having a pH of from 2 to 4,
b) preparing a silica sol or a silica gel from a first silicon oxide precursor at a pH ranging from 2 to 4,
c) mineralizing the emulsion of bitumen drops from step a), with the silica sol or gel from step b),
d) mineralizing the emulsion of bitumen drops resulting from step c) at a pH of less than or equal to 1 with a second silicon oxide precursor,
e) separating the material from the aqueous phase;
heating the aggregates to a temperature ranging from 100° C. to 180° C.,
mixing the aggregates with the road binder,
obtaining bituminous mixes.

33. The process as claimed in claim 32, wherein it comprises heating the aggregates to a temperature ranging from 120° C. to 160° C.

34. The process as claimed in claim 31, which does not comprise a step of heating the road binder before it is mixed with the aggregates.
